(19) United States
(12) Patent Application Publication
(10) Pub. No.: US 2025/0360662 A1
(43) Pub. Date: Nov. 27, 2025

(54) ELECTROMAGNETIC FOAMING

(71) Applicant: NIKE, Inc., Beaverton, OR (US)

(72) Inventors: Tory M. Cross, Portland, OR (US); Martin E. Evans, Portland, OR (US); Denis Schiller, Vancouver, WA (US); Kenneth Kaplan, West Des Moines, IA (US); Michael Mittman, Cambridge, IA (US); Jonathan Tweedt, Ankeny, IA (US)

(21) Appl. No.: 19/178,606

(22) Filed: Apr. 14, 2025

Related U.S. Application Data
(60) Provisional application No. 63/635,011, filed on Apr. 17, 2024.

(51) Int. Cl. B29C 44/34; B29C 44/10; B29C 44/58; B29C 44/60; B29K 67/00; B29L 31/50

(52) U.S. Cl. CPC B29C 44/3415; B29C 44/10; B29C 44/58; B29C 44/60; B29K 2067/00; B29L 2031/50

(57) ABSTRACT

Aspects herein relate to systems and methods to manipulate the distribution of microwave and/or heat energy within a mold chamber retaining a part to be foamed. The chamber may be constructed of a combination of materials with one or more dielectric properties that allow different microwave frequencies to be absorbed, transmitted or reflected in order to obtain a desired distribution of microwave and heat energy within the chamber. A solid-state microwave energy source is combined with a frequency synthesizer to customize the microwave energy being transmitted, and a press may be used to apply pressure to the material within the mold during the manufacturing process. A thermoplastic polymer may be introduced into the mold chamber in the form of a plurality of pellets, granules, beads, or other discrete elements, or in the form of a preform.

### CROSS-REFERENCE TO RELATED APPLICATIONS

This application claims the benefit of U.S. Provisional Application No. 63/635,011, filed Apr. 17, 2024 and entitled “ELECTROMAGNETIC FOAMING.” The aforementioned application is hereby incorporated by reference in its entirety.

### BACKGROUND

Shoes and similar items are often constructed from smaller parts or components made from various materials, including rubber, foams, or other materials that require foaming. Often, such parts are irregularly shaped, presenting a challenge to foam them properly. For example, a typical shoe sole is shaped in a non-uniform manner as the heel portion of the shoe sole may have a shorter width and taller height than the ball portion of the shoe sole. Further, as described below, during a foaming process a volume of the shoe sole material may vary from the heel portion to the ball portion.

### SUMMARY

The present invention generally relates to systems and methods for uniformly foaming a non-uniform workload, such as a shoe part, using a combination of microwave energy and pressure.

Systems and methods in accordance with aspects herein provide a variety of approaches to manipulate the distribution of microwave and/or heat energy within a mold chamber retaining a part to be foamed. The chamber may be constructed of a combination of materials with one or more dielectric properties that allow different microwave frequencies to be absorbed, transmitted or reflected as desired in order to obtain a desired distribution of microwave and heat energy within the chamber, either alone or in combination of other features in accordance with aspects hereof. In aspects, a solid-state microwave energy source is combined with a frequency synthesizer to customize and vary the frequency and intensity/amplitude of the microwave energy being transmitted. In aspects, a press or other apparatus may be used to apply pressure to the material within the mold during the manufacturing process. In some aspects, the press is a part of the overall system or apparatus that is used to heat and foam the shoe part.

In aspects, a thermoplastic polymer is used to form the shoe part. The material may be in a pre-molded form of a plurality of pellets, granules, beads, or other discrete elements that may be introduced into the mold chamber. In aspects, the discrete elements have a blowing agent infused or otherwise incorporated within. In aspects, the discrete elements comprise Thermoplastic Polyester Elastomer (r-TPEE) and a blowing agent. In other aspects, the discrete elements may be processed in a preliminary step to form a preform having a desired shape and material distribution that is then introduced into the mold chamber.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE DRAWINGS

Examples of aspects herein are described in detail below with reference to the attached drawing figures, wherein:

FIG. 1 illustrates an exploded schematic cross-section side view of a system in accordance with an aspect hereof;

FIGS. 2A-D illustrate cross-section views of the assembled system of FIG. 1 during various steps of a manufacturing process in accordance with aspects hereof;

FIG. 3 is a flow chart of a method of manufacture in accordance with an aspect of the present invention.

FIGS. 4A-B illustrate schematic side views of several aspects of preforms formed in accordance with another aspect hereof;

FIG. 5 is a flow chart of an optional preliminary process of the method of manufacture of FIG. 3.

FIG. 6 illustrates a schematic cross-section side view of a system component in accordance with a second aspect hereof;

### DETAILED DESCRIPTION

An article of footwear, such as a shoe, may be formed from a variety of components. For example, a shoe includes a sole portion that provides a variety of functional benefits to the shoe. As such, the formation of the sole from a process and a material selection perspective is foundation to achieving advantages from the sole. A sole is traditionally formed from a foamed polymeric composition, but the traditional process of forming a foamed sole has limitations that consequently limit the ability to achieve desired characteristics of the sole. As will be described in detail hereinafter, aspects herein contemplate a bespoke distribution of electromagnetic energy (e.g., microwave energy) and systems for that distribution to tune the formation of a polymeric foamed component, such as a component forming a shoe sole. In addition to providing tuned electromagnetic energy distribution and tools of accomplishing the same, the concepts contemplated herein also tune the process and resulting article through a material selection. An example of material selection factors considered to achieve the intended foamed article under the contemplated approach, a tuned dielectric microwave permittivity characteristic is considered for the materials to which the electromagnetic energy is applied.

As used herein, a foam is a material formed by trapping bubbles or pockets of gas within a solid matrix. In traditional foaming techniques, a quantity of material to be foamed (known as a “load”) is contained within a chamber of a mold and heated under pressure until the blowing agent is activated. The load may initially be in a solid form prior to heating and in a liquid form during blowing agent activation. The mold may then be held under pressure until the load cools, after which the mold is opened; upon opening, the foaming reaction takes place and the foamed part expands and pops out of the mold chamber. Traditional sources of heat for this process include ovens or heat presses that rely on resistive heat generation.

Characteristics of a load may affect the uniformity of the resulting component formed from the load during the foaming process. These characteristics may include a silhouette, a volume, a mass, a length, a width, a height, a type of material, a location of the load in relation to the source of heat or energy being used, and/or a location of the load in relation to a portion of the mold chamber. As a result, one portion of the load within the chamber may require an amount of energy different from another portion of the load within the same chamber in order to achieve the desired temperature. For example, a heel portion of a shoe sole may have a larger mass than a ball portion of a shoe sole and therefore a tuned electromagnetic energy distribution and related tooling may be utilized to foam the shoe sole.

Customizing the energy distribution throughout the chamber may allow for a part, such as a shoe sole, to be foamed uniformly despite having a non-uniform shape or other non-uniform characteristics. However, achieving this customized energy distribution throughout a small volume, such as within the mold chamber for a shoe part, can be difficult with traditional heating sources such as ovens or heat presses, which are typically designed to heat large volumes in an indiscrete manner. Furthermore, these traditional heating methods, which require the heating not just of the load but also of the mold, the oven or press itself, and the medium by which the heat is transferred to the mold (e.g., the air within an oven), result in a large amount of energy being wasted in the form of excess heat.

More recently the use of electromagnetic radiation, such as microwave energy, to foam shoe parts has been explored. Microwave energy is a form of electromagnetic radiation. Microwaves may have a wavelength that range from one meter to one millimeter, with corresponding frequencies between 300 MHz (1 meter wave length) to 300 GHz (1 millimeter wavelength). Microwave energy can interact with materials based on a number of factors (e.g., power, frequency, proximity, beam shape) to cause a generation of thermal energy known as dielectric heating. In many situations, dielectric heating is typically more efficient than heating via traditional heating sources such as ovens or heat presses that rely on traditional heating elements, such as resistive heating, because the microwave energy can be absorbed directly by the target and converted to heat, instead of having to conduct heat energy through a physical conduit (e.g., the air within an oven chamber or the metal of a heat press platen).

However, several issues that have been encountered in efforts to use microwave heating technologies in a foaming manufacturing process. These include the “blow torch effect” (excessive heating at the initial point of contact of microwave energy with the load) and difficulties in properly “tuning” the chamber to uniformly heat the material in the mold.

It has proved particularly difficult to utilize microwave energy from traditional microwave energy sources (e.g., magnetrons) with small chambers of a size required for a typical shoe part. A fixed frequency microwave signal launched within a microwave chamber is reflected a plurality of times, eventually establishing modal patterns of energy distribution. The overall distribution of electromagnetic energy is not uniform throughout the microwave chamber, resulting in both high and low energy field areas, i.e., hot and cold spots.

Another difficulty encountered is that many of the typical materials used to form shoe parts, such as ethylene-vinyl acetate (EVA), are not particularly suited for heating via microwave energy. A large component of dielectric heating occurs through a phenomenon known as orientation polarization (also known as dipolar polarization), in which polar molecules in a material rotate to align themselves with a microwave's electric field. Because the microwave's electric field is constantly oscillating, the molecules in turn are constantly moving, leading to molecular friction and collisions that result in rapid heating of the material. However, some materials do not experience significant orientation polarization when subjected to microwave energy. In particular, it has been observed that EVA, a material widely used in shoe manufacturing, is not efficiently heated via microwave energy, perhaps due to the length of its molecules.

To address these issues, systems and methods in accordance with aspects herein provide a variety of approaches to manipulate the distribution of microwave and/or heat energy within a chamber retaining a part to be foamed.

Some aspects described herein generally relate to systems and methods for customizing a distribution of microwave energy within a chamber to uniformly process a non-uniform workload. Aspects of the present invention may use a microwave energy source comprising a solid-state transistor and frequency synthesizer. Compared with traditional sources such as magnetrons, such a microwave energy source allows for more precise tuning of the amplitude and frequencies of the microwave energy being leveraged by the system while also generating microwaves more efficiently, reducing the amount of power required. A computing device may be coupled to the microwave energy source to adjust the application of microwave energy based upon parameters such as the time elapsed within a manufacturing cycle, and/or the temperature measured by one or more sensors. Additionally, aspects of the system, which may include a mold and a press, comprise one or more components formed of materials with different dielectric properties that are chosen in order to selectively configure the energy and heat distribution being applied to the load within the mold. By selecting the placement of different materials that can absorb, reflect or transmit the microwave energies being used, additional energy may be directed to different portions of the mold chamber as desired. For example, some portions of the mold may be formed of a material that will absorb the microwave energy and be heated up, which in turn can transfer heat to adjacent portions of the load in the chamber via conduction. This allows for the system additional mechanisms to transfer energy (in the form of microwaves or heat) to a load within the mold chamber in a discrete manner.

Additionally, it has been found that a blend comprising recycled polyethylene terephthalate (PET) and a blowing agent is sufficiently responsive to microwave energy and expands well even under sub-optimal conditions. In particular, a material called recycled Thermoplastic Polyester Elastomer (recycled TPEE or r-TPEE) has been found to readily absorb microwave energy and heat rapidly, and is conducive to foaming. r-TPEE may use post-consumer recycled (PCR) and/or PET bottles as feedstock. A specific r-TPEE contemplated herein has a relatively low carbon impact, being manufactured from post-consumer recycled PET bottles and having an estimated total CO₂e of about 1.3 Kg/Kg of r-TPEE, where CO₂e represents the number of metric tons of CO2 emissions with the same global warming potential as one metric ton of another greenhouse gas, and is calculated using Equation A-1 in 40 CFR Part 98. In addition to r-TPEE being a suitable material for dielectric heating, shoe parts formed from r-TPEE exhibit acceptable characteristics (e.g., rebound, durability) and remain recyclable when introduced into a waste stream. Thus, the use of r-TPEE to form shoe parts using systems and methods described herein offer significant sustainability advances by reusing waste material as feedstock, reducing energy used in manufacturing the shoe part, and, and minimizing waste material at the end-of-life. However, it is to be appreciated that non-recycled materials, such as TPEE that does not include any recycled content, may also be used in accordance with the present disclosure.

In aspects, the r-TPEE (or other material to be foamed) is introduced into the mold (i.e., a cavity formed within the mold) in the form of pellets or other discrete elements. In other aspects, the material can be preformed into different shapes. For example, r-TPEE-containing discrete elements can be introduced into a preform mold having a volume with the same or different dimensions in a least one aspect to the volume of the mold chamber. The preform mold is then heated to a temperature that causes the discrete elements to adhere to each other but the discrete elements are not heated to a temperature where the blowing agent is materially activated and foaming of the composition substantially begins. The preform may be heated via traditional methods (e.g., convection, conduction) and/or application of microwave energy (referred to herein as microwave for convenience). The preform can then be taken out of the preform mold and introduced into the mold. An optional cooling step may take place prior to removing the preform from the preform mold.

Using a preform may allow for a more precise distribution of material in specific areas of the mold to be achieved, which may then result in different properties being realized in the corresponding portions of the foamed part. For example, a preform can be used is in connection with the forming of a shoe sole component having non-uniform volumes along the component where a loose pellet application may not result in an appropriate distribution of material to fill a mold volume forming the non-uniform component shape. Using a preform can help ensure a sufficient material volume is positioned at appropriate places within a mold volume to sufficiently fill and form the resulting component, or alternatively, to allocate an additional or lesser amount of material in one or more portions of the volume of the mold so that different properties are exhibited by the formed component in those portions.

Dielectric properties such as dielectric constant and dielectric loss factor affect the intensity and rate of heating a material experiences when exposed to microwave energy. At a high level, the relative permittivity (also known as the dielectric constant) of a material indicates the ability of the material to absorb microwave energy, while the dielectric loss factor explains the ability of the material to convert the absorbed microwave energy to heat. A material with a higher relative permittivity means that more microwave energy can be stored in the material than one with a lower relative permittivity. The relative permittivity of a vacuum is 1, with all other materials having a relative permittivity greater than 1. A material with a higher dielectric loss factor will dissipate more energy in the form of heat than a material with a lower dielectric loss factor.

A material's response to microwave energy may also be dependent upon factors such as temperature or phase, and may be specific to a particular wavelength. For example, with respect to radio frequency (RF) energy in the microwave band, water in liquid form will absorb the energy and heat rapidly, while ice is largely transparent to microwave energy.

A material's response to microwave energy also depends on the ability of microwaves to penetrate into or through the material. Materials where this penetration is essentially zero, e.g., metals, reflect microwave energy. On the other side of the spectrum are materials where penetration is infinite (i.e., the microwaves pass through completely without loss); these materials are considered to be transparent to microwave energy. For materials between these two ends of the spectrum, the outer layer of material will absorb some amount of microwave energy with the remainder passing deeper into the material until it is gradually absorbed or passes through.

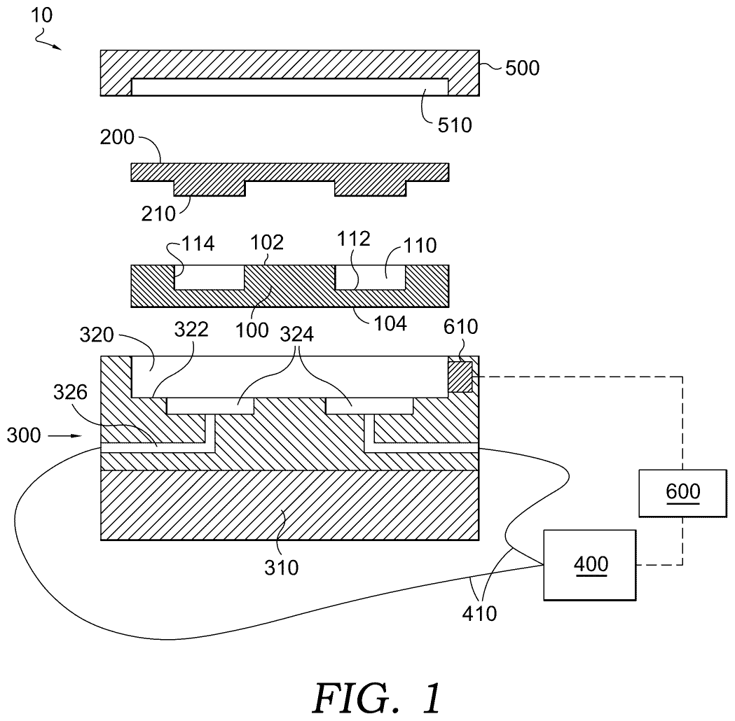

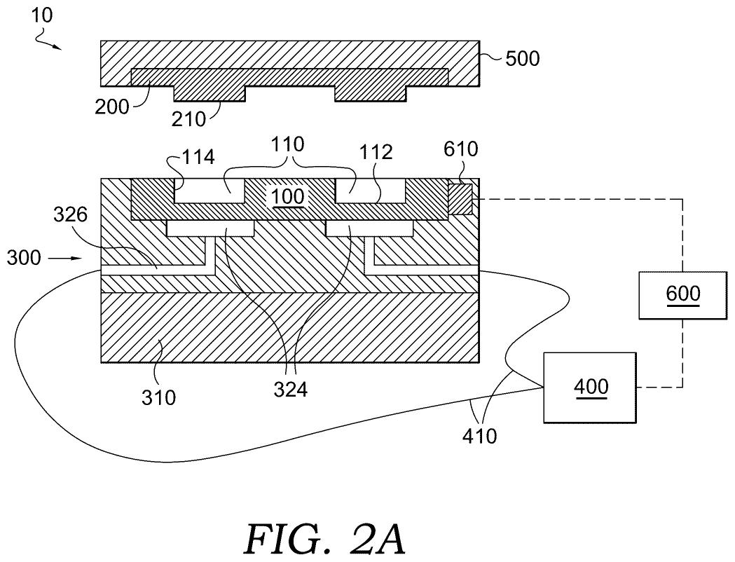

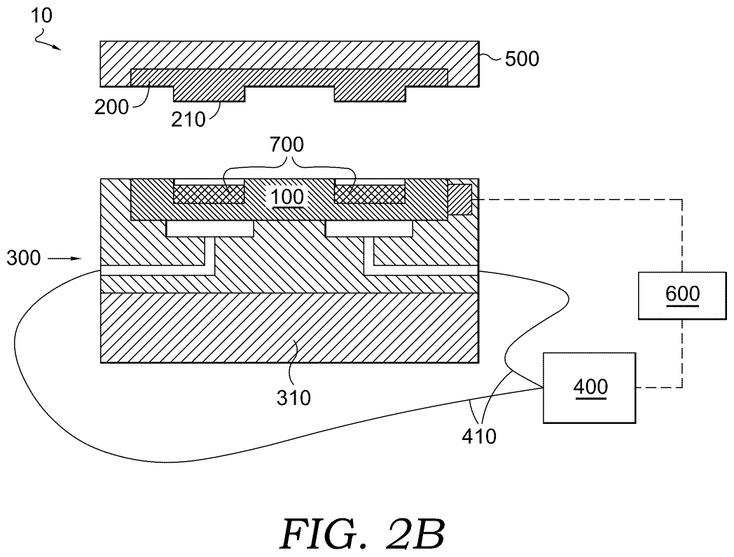

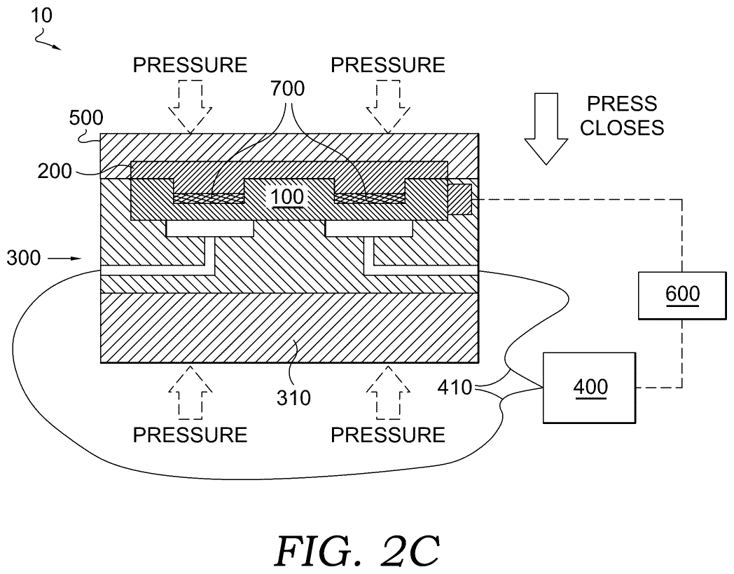

With reference now to FIGS. 1 and 2A-D, which provide schematic cross section illustrations of a system 10 for molding an article with microwave energy in accordance with aspects hereof, a high level description of the components of the system 10 is now provided. The system 10 includes a mold base 100 having one or more mold chamber 110 and a mold cover 200 configured to fit over the mold base 100 and seal the mold chambers 110. The mold base 100 and mold cover 200 are configured to fit in a press comprising a press base 300 and a top press plate 500. A microwave energy source 400 is coupled to the press base 300 via transmission lines 410. A computing device 600 is connected to the system 10 and is capable of controlling its operation.

Turning now to a more detailed description of the various components of system 10 in accordance with an aspect herein, the mold base 100 has a top surface 102, a bottom surface 104 and the at least one mold chamber 110. Each mold chamber 110 has a mold chamber bottom 112 and mold chamber sidewalls 114. In an aspect, the mold base 100 may be formed from a material that is effectively transparent to the microwave frequencies being used; examples of such materials include certain ceramic materials (such as alumina, magnesia and silica), Teflon, quartz and glass. In aspects, mold chamber sidewalls 114 may comprise multiple materials, each having a different dielectric property or properties to the microwaves frequencies being used, and therefore different responses and interactions with the microwaves. For example, some or all of the mold chamber sidewalls 114 may comprise or be lined with a material, such as silicon carbide, that absorbs at least some of the frequencies being emitted from the microwave energy source 400 and undergo dielectric heating; the heated mold chamber sidewalls 114 subsequently transfer heat to the load via conduction. In another example, at least a portion of mold chamber sidewalls 114 may be lined with a material (e.g., metals) that reflects at least some of the frequencies being leveraged, in which case the microwaves are reflected back into the load mass. As used herein, having a surface “lined” with a material can mean having the surface coated with the material or having a discrete layer of the material joined to the surface; the joining of the lining to the surface can be accomplished via any number of suitable methods, such as the use of bonding, adhesives, and/or using mechanical connectors.

As seen in FIGS. 1 and 2A-C, mold cover 200 includes upper mold plates 210 corresponding to the number of mold chambers 110 in the mold base 100 and effective for forming a sealed mold chamber when in a closed configuration with the mold base 100. The mold cover 200 is configured so that can be inserted into the pressing surface 510 of top press plate 500. The mold cover 200 and the upper mold plates 210 may be comprised of a material that is microwave reflecting, microwave transparent or microwave absorbent, depending upon the characteristics desired. In an aspect, some or all of upper mold plates 210 are formed from, lined with, or otherwise associated with a material that absorbs at least some of the microwave frequencies leveraged. For example, if it is desired for the load to be heated by a combination of direct microwave energy absorption and heat transfer via conduction from the upper mold plates 210, then a lining of material can be used to form or to line the surface of upper mold plates 210 such that it absorbs certain microwave frequencies that pass through the load material (or otherwise reflect within the mold). In other aspects, some or all of the upper mold plates 210 are formed from or are lined with a material that reflects at least some of the microwave frequencies being used. This alternative construction allows for microwave frequencies that are absorbable by the material but have managed to pass through the material in the mold chamber 110 the first time through to be reflected back into the mold chamber 110, allowing them another opportunity to be absorbed by the load material.

Upper mold plates 210, mold chamber bottoms 112 and mold chamber sidewalls 114 may be formed to provide shape, textures, patterns or designs, etc. to one or more surfaces of the part being foamed. In the aspect shown in FIG. 1, the mold base 100 is a separate component from the press base 300 and the mold cover 200 is a separate component from the top press plate 500. In other aspects, one or both of the mold base 100 and mold cover 200 can be integrated into the press base 300 and/or top press plate 500, respectively.

The press base 300 of the system 10 comprises a bottom press plate 310, and a bed 320 into which mold base 100 can be inserted. The top surface 322 of the bed 320 has one or more windows 324, which are each coupled to corresponding conduits 326. As used herein, a “window” is a portion of a component that is more transparent or permissive to microwave energy than surrounding portions. Windows 324 are formed from a material that is effectively transparent to the microwave frequencies being emitted by the microwave energy source 400. In an aspect, suitable materials for the windows 324 may include ceramic, fused silica/quartz, polytetrafluoroethylene, or polyether ether ketone. In another aspect, the windows 324 are physical apertures in the top surface 322 of the bed 320, as air is largely transparent to microwave energy. In aspects, windows 324 may have one or more portions made of a different material having a different set of dielectric properties; such a configuration may allow for greater customization of the microwave energy and heat distribution provided to the load 700 within the mold chamber 110.

Microwave energy source 400 (comprising a power source, a solid-state element and at least one frequency synthesizer) provides the microwave energy used by the system 10. In an aspect, the microwave energy source 400 is coupled to the windows 324 in press base 300 via a combination of transmission lines 410 and conduits 326. As used herein, “transmission lines” refer to the structures that propagate microwave energy from the microwave energy source to the press base 300, while “conduits” refer to the structures that propagate the microwave energy through the press base 300 to the windows 324. In aspects, the transmission lines 410 and conduits 326 comprise one or more combinations of RF coaxial cables and waveguides selected to be compatible with the microwave wavelengths being leveraged. In an aspect, the coaxial cables allow for flexible installation and accommodates potential movement of different components of the system, including the mold. In an aspect, an antenna device may be used to transition the energy from the coaxial cable to the waveguide. It is contemplated to be within the scope of this disclosure to have systems that use only waveguides or only coaxial cables, or other suitable transmission structures for propagating microwave energy. In an aspect, waveguides comprising steel or aluminum channels with rectangular section of prescribed dimensions, related to the wave length, may be used. In an aspect, the waveguides may have a rectangular section with interior dimensions of about 86 mm in width and about 43 mm in height).

It is contemplated that the microwave energy used herein may be within a particular frequency range in an exemplary aspect. For example, the range of energy may be within the band between 2400 and 2500 MHz, which is one of the two bands allowable under current applicable broadcast regulations, and which is the frequency band that many widely available commercial microwave ovens operate in. However, notwithstanding any regulatory limitations, is contemplated that any microwave or even radio frequency (RF) may be implemented in exemplary aspects hereof, depending upon the nature of the materials of the load and the components of the system, as further described herein. In an aspect, the microwave energy source 400 changes frequencies in a serial manner; that is, it provides microwaves at a first frequency for a first time period, then switches to a second frequency for s second time period, and so on. Thus, multiple frequencies can exist within the mold chamber at the same time. In another aspect, more than one microwave energy source may be used to deliver microwave energy at the same or different frequencies to the same mold chamber.

In an aspect, the computing device 600 comprises a processor communicatively coupled to a memory device, with the memory device capable of saving instructions and the processor capable of processing instructions saved on the memory. The computing device 600 is communicatively coupled to one or more sensor components 610, which may comprise one or more sensors (e.g., thermocouple, pressure sensor) to measure parameters such as temperature, pressure, etc., within the mold chambers 110 and/or one or more of the other system components. In an aspect, the computing device 600 is also communicatively coupled to the press; in these aspects, the computing device 600 may also be used to control the opening and closing of the press and the amount of pressure being applied to the mold. For example, the computing device 600 may adjust the transmission of microwave energy from the microwave energy source 400 and/or the amount of pressure applied by the press based upon parameters such as the time elapsed within a manufacturing cycle and/or the temperature measured by the sensor component 610. While FIGS. 1-2 show a single sensor component 610, it is to be appreciated that this is a schematic representation, and one of skill in the will readily understand that one or more sensor components (each having one or more types of sensors) can be used in one or more locations within or proximate the system 10.

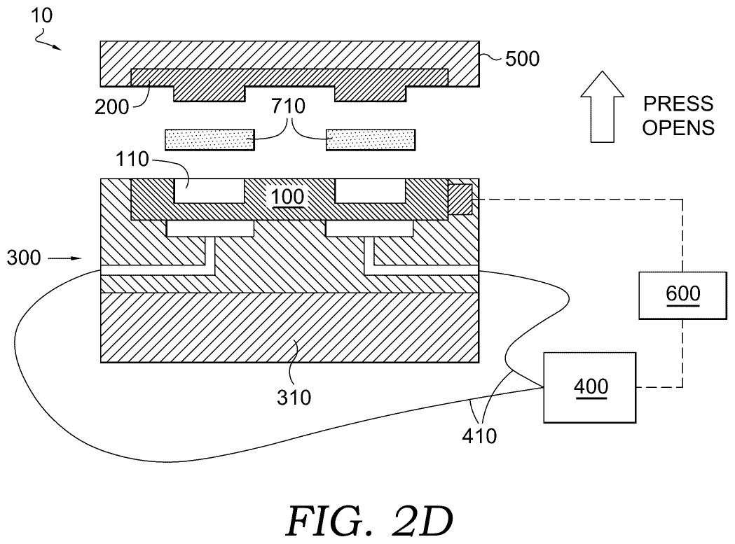

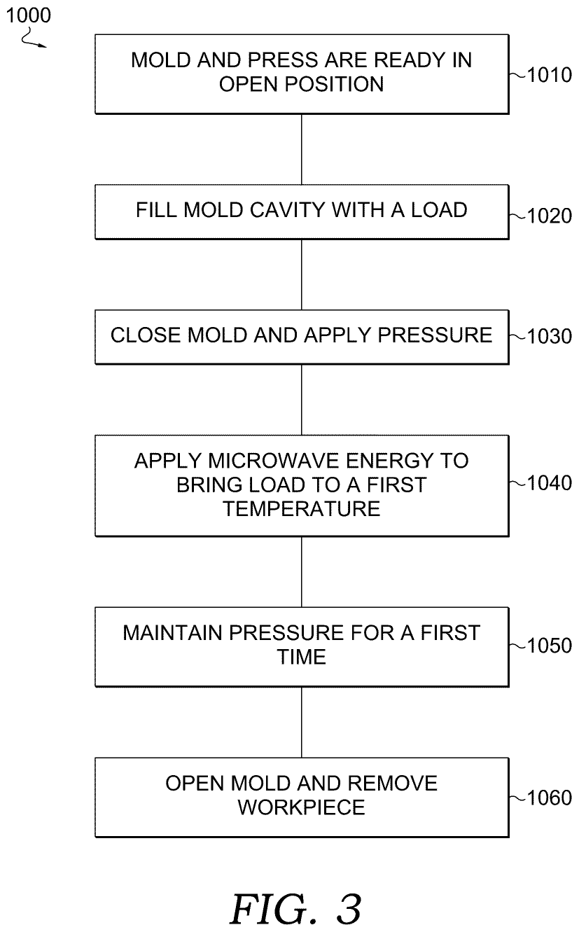

An aspect of practicing the present concept is illustrated in FIGS. 2A-D, with a corresponding block diagram of a process 1000 for foaming a part being illustrated in FIG. 3. In a first step 1010, the system 10 is in an open and ready position (such as, for example, as illustrated in FIG. 2A), with the mold cover 200 inserted into the pressing surface 510 of the top press plate 500 and the mold base 100 inserted into the bed 320 of the press base 300.

In step 1020 and as illustrated in FIG. 2B, a desired amount of material to be foamed (load 700) is loaded into each of the mold chambers 110. In an aspect, the load 700 r-TPEE is in the form of pellets or other discrete elements such as beads or granules. In aspects, the pellets may be from about 2 to 4 mm in diameter, or from about 1 to 10 mm in diameter. In other aspects, the r-TPEE or other polymer material can be introduced into the mold chamber in other forms of discrete elements. For example, the material may be in the form of long strands or blocks of material, which may be formed by extrusion or other suitable manufacturing methods. Being able to provide the material in different forms may reduce costs (e.g., by reducing amount of processing necessary to prepare the material) or provide greater control of the amount of material being introduced into the mold chamber 110.

In an aspect, discrete elements of different shapes and sizes may also be used together; this may have the advantage of reducing the amount of unoccupied space in the mold by having smaller discrete elements fit in the interstices between larger discrete elements. In aspects using r-TPEE discrete elements (e.g., pellets), the material to be foamed and a blowing agent are integrated together into the pellets (e.g., by infusing the pellets with the blowing agent), which may provide additional convenience in simplifying the step of loading the material into the mold during the manufacturing process. In other aspects the material to be foamed and the blowing agent can be separately added into the mold chamber 110, which can be advantageous in allowing more flexibility in being able to tune the ratio of material to blowing agent for specific applications.

In an aspect, the mold is then slightly agitated in order to more evenly distribute the discrete elements within the mold chamber. Other methods of redistributing the discrete elements may also be used, such as, for example, using a mechanical device to stir the pellets within the chamber. In other aspects the blowing agent or other additive is omitted when it is not needed to achieve the desired outcome.

The load 700 may be introduced into the mold chamber 110. In an aspect, the temperatures of the mold and the discrete elements are both at ambient temperature (about 5-27° C.). In another aspect, the mold is preheated while the discrete elements are kept at a lower temperature until introduced into the mold. In an aspect, the mold is preheated to about 170° C., and the discrete elements are kept at a temperature of less than 50° C. until introduced into the mold.

In step 1030, the press is activated and the top press plate 500 and the bottom press plate 310 come together to close the mold cover 200 onto the mold base 100 and optionally to apply continuous pressure, as illustrated in FIG. 2C. In the example shown in FIG. 2B, the load 700, after being introduced into the mold chamber 110 but prior to the closing of the mold cover 200, occupies a greater volume than the volume of the mold chamber 110 after the mold cover 200 is closed over the mold base 100. Thus, the load 700 as shown in FIG. 2C is compressed by the mold chamber bottom 112, mold chamber sidewalls 114, and upper mold plates 210 when the mold chamber 110 is closed. In other aspects, the load 700 may occupy an equal or lesser volume than the closed mold chamber 110. By having this flexibility, the system 10 is capable of forming a wider variety of parts with different desirable characteristics. For example, by being able to accommodate loads that would otherwise exceed the volume of the mold chamber 110, parts can be formed by the system 10 with greater density that could otherwise be achieved.

In step 1040 the computing device 600 activates the microwave energy source 400 to emit microwave energy in the desired frequencies, intensities, and duration. The computing device 600 may adjust frequencies and intensities of the microwave energy based on input from the sensor component 610, or it may follow a preset routine. In an aspect, microwave energy is applied to the load 700 until a first temperature is reached that is sufficient for the blowing agent to be activated and foaming of the r-TPEE has started.

The microwave frequencies to be used are selected so that heat can be distributed according to desired profile. For example, the microwave frequency that is most readily absorbed by the load (e.g., r-TPEE) should not be used exclusively, as this would result in all the energy being captured at the outer surface of the load adjacent to the point where microwave energy is entering the mold chamber 110, for example, along the mold chamber bottom 112 adjacent the window 324, resulting in overheating of that portion of the load 700. Instead, one or more frequencies should be selected so that a desired portion of the microwaves are able to penetrate into the interior portions of the load 700 in the mold chamber 110. Alternatively and/or in addition, frequencies can be used for which the load 700 is transparent but that are absorbed by material in the upper mold plates 210, so that the top press plates will be heated and transfer that heat via conduction to the part of the mold chamber most distant to the entry point of the microwave energy adjacent to windows 324. In this way the system 10 can be tuned to optimize the energy and heat transfer to the load as desired in order to achieve the desired outcome for the final foamed part. In other aspects, the configuration of the materials used to form the various component of the assembly, together with the selection and configuration of the microwave energies introduced into the mold chamber 110, result in a plurality of zones within the mold chamber 110, where the microwave energy applied to one zone has at least one different characteristic than the microwave energy applied to at least one other zone. This zoning technique may be used in combination with other techniques described herein to further tailor the energy being directed into different parts of a load 700 within the mold chamber 110.

A variety of materials may be used to form the various components of the assembly, depending upon the dielectric properties desired. Each material has one or more dielectric properties that provide an indication as to a degree/type of response that will be recognized based on factors of the microwave energy. For example, a first material may substantially reflect microwave energy at a first set of factors, a second material may substantially be transparent to the microwave energy at the same first set of factors, and a third material may convert the microwave energy into thermal energy using dielectric heating. Stated differently, the first material may reflect microwave energy of a certain frequency, intensity and orientation; the second material may allow the microwave energy with those same characteristics to pass through it; and the third material absorbs that same microwave energy and gets hot as a result.

Materials that are effectively transparent to the frequencies most readily absorbed by r-TPEE include alumina ceramics, fused silica or quartz, polytetrafluoroethylene, and polyether ether ketone. Materials that are effectively reflective to the frequencies most readily absorbed by r-TPEE include silicon carbide ceramics. It is to be understood that other properties, such as durability, reaction to temperature and pressure, cost, availability, and sustainability should also be taken into account when selecting the materials to be used for the system components. Furthermore, it may be desirable to shield certain parts or components of the system 10 (e.g., the computing device 600, power cables, other electronics, etc.) from microwave energy using sheathes, coatings or deflectors. While not expressly described herein, it is also to be appreciated that one of skill in the art may also apply known techniques (such as the use of waveguides, deflectors, distribution plates, conducting rods, etc.) in combination with the teachings herein to further customize the distribution of microwave energy into the microwave chamber.

The load 700 with the mold chamber 110 is brought to a peak temperature that is in the range of up about 170° C. over a period of from about 30 to about 300 seconds. In aspects, the various variables are selected so that the various parts of the load 700 are is uniformly heated.

A desired skin thickness of the finished part may be achieved by selection of the maximum heating temperature within the temperature range. Skin thickness may be selected to alter cushioning and feel of a molded midsole as used in an article of footwear. The skin thickness on a molded part may be at least about 60 micrometers. In various aspects, the peak temperature is selected to produce a skin thickness of from about 50 micrometers to about 300 micrometers. The computing device 600 may then be used to instruct the microwave energy source 400 to stop supplying microwave energy to the system 10, and the mold is then cooled to a temperature of from about 170° C. to about 20° C. over a period of from about 300 to about 900 seconds.

In step 1050, the load 700 is kept under pressure during the heating and cooling process until enough time has passed for the blowing agent process to be completed. While not always necessary, pressure is often required to achieve the desired results during this process. The level of such pressure depends upon the characteristics of the material and the desired characteristics of the finished part, such as specific gravity, and other relevant factors. In the example shown in FIGS. 1 and 2, pressure to the mold may come from a conventional press exerting pressure via top press plate 500 and bottom press plate 310.

In step 1060, and as illustrated in FIG. 2D, once the load 700 has been cooled sufficiently, the computing device 600 instructs the press to release the pressure and the top press plate 500 and bottom press plate 310 are retracted from each other, opening the mold cover 200 away from the mold base 100. Once the pressure is released the load 700 will undergo a foaming process to form the foamed part 710. In an aspect using r-TPEE, the mold can be opened once the load has cooled to temperature of about 25° C. or less.

In an aspect, the foamed part 710 will want to expand to a volume that is greater than that of the mold chamber 110, which may cause the foamed part 710 to spontaneously pop out of the mold chamber 110 once the mold cover 200 is removed.

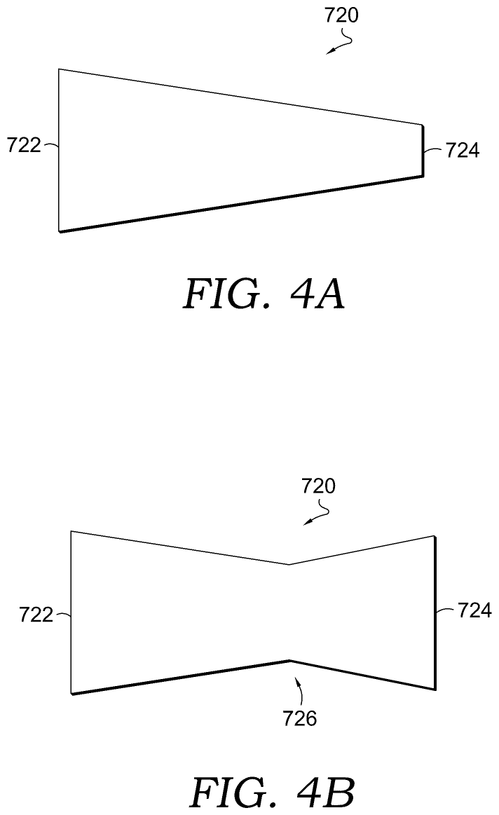

In alternative aspects, the load 700, instead of being introduced into the mold chamber 110 as pellets or other discrete elements, may be in the form of a preform 720 that is created from the pellets in a preliminary step. A preform 720 may be advantageous to use, for example, if it is desirable to more precisely concentrate additional material in one or more areas of the foamed part 710. For example, as shown in FIG. 4A, a preform 720 can have a wedge-like shape, with the thicker portion of the wedge at the heel end 724. Other more complex preform shapes are also possible. For example, the preform of FIG. 4B has a greater thickness in both the toe end 722 and the heel end 724 than in the middle 726, which may provide a greater density in those regions of the foamed part 710, even if the corresponding portions of the finished part (e.g., the toe region) have thicknesses less than the middle. Preforms may be used regardless of whether the volume of the preform in certain regions is less than, equal to, or greater than the correspondence volume of the mold chamber 110, as long as it is still possible to fully close the mold.

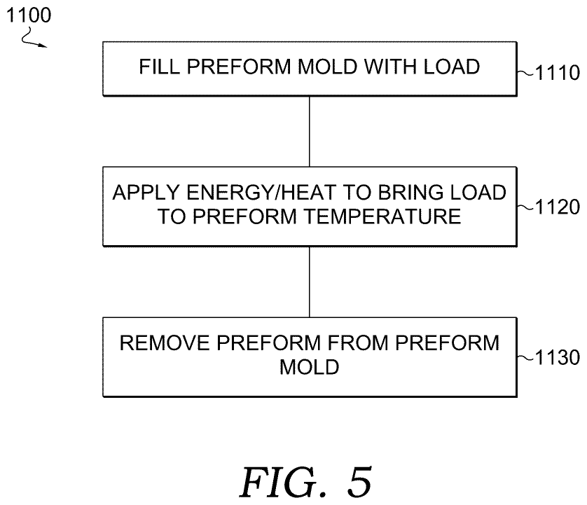

In an aspect of the preform process 1100 as illustrated in FIG. 5, in a first step 1110 a preform load, which may be in the form of pellets or other discrete elements, is introduced into a preform mold chamber. In a second step 1120 the preform load is then heated until it reaches a temperature where the pellets begin to melt and fuse with each other but below the temperature where the blowing agent may be activated. The heating of the preform load during the preform process may use traditional heat sources (e.g., ovens or heat plates), microwaves, or a combination of both. For example, an oven may be the best option to use if the preform is not complex in shape and many preform molds can be heated in the same oven. Alternatively, microwave heating may be preferred if the preform shape itself is complex and more discrete heating of various portions is desirable. In a third step 1130 the preform load is then cooled and then removed from the preform mold, before being used in the foaming manufacturing process of the present invention as described above in place of the loose pellets.

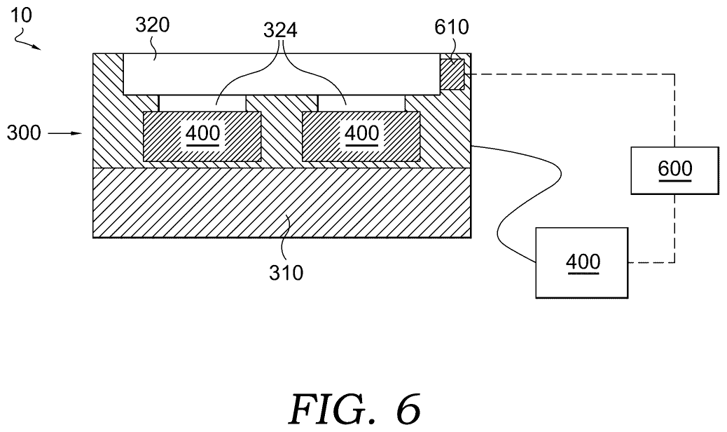

Many variations on aspects of the system 10 are possible within the scope of the present invention. For example, FIG. 6 illustrates a system 10 having a separate microwave energy source 400 for each of the two mold chambers 110, with the microwave energy sources 400 being integrated within the press base 300 and immediately adjacent the windows 324, eliminating the need for conduits and/or transmission lines to propagate the microwave energy from the microwave energy sources 400 to the mold chambers 110. Other methods of applying, maintaining and releasing pressure, such as via vacuum sealing, may also be used.

Other variations in the system may include changing the orientation of the mold chambers 110 with respect to the direction of pressure applied by the press or the directional axis of microwave energy as it is initially being propagated into the mold.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. A system for foaming a component of an article of footwear, the system comprising: a solid-state microwave energy source comprising a frequency synthesizer; a footwear component mold, the footwear component mold having a mold chamber configured to form the component from a polymer material reactive to microwave energy from the solid-state microwave energy source, the footwear component mold comprising a first material having a first value for a first microwave dielectric property; and a press, the press capable of compressing one or more portions of the footwear component mold.

Clause 2. The system according to clause 1, wherein the solid-state microwave energy source comprises an emitter capable of varying electromagnetic wavelengths, field configurations, or intensity across the emitter.

Clause 3. The system according to clauses 1 or 2, wherein the solid-state microwave energy source is coupled with the footwear-component mold by a microwave energy conduit.

Clause 4. The system according to any of clauses 1 to 3, wherein the solid-state microwave energy source generates electromagnetic radiation in a frequency of between about 2.4 GHz and 2.5 GHZ.

Clause 5. The system according to any of clauses 1 to 4, wherein the footwear component mold comprises a second material having a second value for the first microwave dielectric property.

Clause 6. The system according to any of clauses 1 to 5, wherein the first microwave dielectric property is relative permittivity, and wherein the first value is less than the second value for a first frequency of microwave energy from the solid-state microwave energy source.

Clause 7. The system according to any of clauses 1 to 6, wherein the first value for the first microwave dielectric property is different than a second value for the first microwave dielectric property for the polymer material.

Clause 8. The system according to any of clauses 1 to 7, wherein the polymer material is thermoplastic polyester elastomer.

Clause 9. The system according to any of clauses 1 to 8, further comprising a computing system logically coupled with the solid-state microwave energy source and the press, wherein the computing system is configured to coordinate an application of microwave energy from the solid-state microwave energy source and an application of force by the press to the footwear component mold.

Clause 10. A method of manufacturing a foam component for an article of footwear, the method comprising: introducing a polymer material into a mold chamber of a footwear component mold; closing the footwear component mold into a closed state having a substantially fixed mold volume; applying microwave energy across multiple frequencies to the polymer material in the footwear component mold until a start of a foaming process is experienced by the polymer material; subsequent to applying the microwave energy, maintaining the footwear component mold in the closed state for a first time so that the foam component is formed; and subsequent to the first time, opening the footwear component mold from the closed state.

Clause 11. The method according to clause 10 further comprising forming a preform from the polymer material, wherein the introducing of a polymer material a mold chamber comprises introducing the preform into the mold chamber.

Clause 12. The method according to clause 11, wherein the preform has a volume prior to applying microwave energy that is greater than a volume of the mold chamber in the closed state.

Clause 13. The method according to clause 11, wherein the preform has a volume prior to applying microwave energy that is less than a volume of the mold chamber in the closed state.

Clause 14. The method according to any of clauses 11 to 13, wherein forming the preform comprises: introducing the polymer material into a preform mold; applying thermal energy to the polymer material in the preform mold to form the preform; and removing the preform from the preform mold.

Clause 15. The method according to any of clauses 10 to 14, wherein the footwear component mold comprises a plurality of zones, and the microwave energy applied to one zone has at least one different characteristic than the microwave energy applied to at least one other zone.

Clause 16. The method according to any of clauses 10 to 15, wherein the polymer material is introduced as a plurality of discrete elements.

Clause 17. The method according to clause 16, wherein the plurality of discrete elements are in a pellet configuration.

Clause 18. A method of manufacturing a foam component for an article of footwear, the method comprising: introducing a polymer material comprising thermoplastic polyester elastomer into a molding chamber of a preform mold; heating the polymer material to a first temperature; subsequent to heating the polymer material to a first temperature, maintaining the polymer material in the preform mold until the polymer material is below the first temperature; removing the polymer material from the preform mold, wherein the polymer material forms a preform having a first volume; inserting the preform into a molding chamber of a footwear component mold; closing the footwear component mold into a closed state having a second volume; heating the preform to a second temperature by applying microwave energy from a solid-state microwave energy source comprising a frequency synthesizer that varies a frequency of electromagnetic radiation emitted, wherein the second temperature is higher than the first temperature; subsequent to applying the microwave energy, maintaining the footwear component mold in the closed state for a first time until the polymer material of the preform cools to a third temperature; and subsequent to the first time, opening the footwear component mold from the closed state.

Clause 19. The method according to clause 18 further comprising subsequent to heating the preform and prior to opening the footwear component mold from the closed state, decoupling the footwear component mold from the solid-state microwave energy source and transferring the footwear component mold relative to the solid-state microwave energy source.

Clause 20. The method according to clause 19 further comprising subsequent to decoupling the footwear component mold from the solid-state microwave energy source and transferring the footwear component mold relative to the solid-state microwave energy source: inserting a second preform into a molding chamber of a second footwear component mold; closing the second footwear component mold into a closed state; positioning the solid-state microwave energy source relative to the second footwear component mold; and applying microwave energy from the solid-state microwave energy source to the second preform within the second footwear component mold.

The subject matter of the present invention is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” and/or “block” might be used herein to connote different elements of methods employed, the terms should not be interpreted as implying any particular order among or between various steps herein disclosed unless and except when the order of individual steps is explicitly stated.

Aspects of the present disclosure have been described with the intent to be illustrative rather than restrictive. Alternative aspects will become apparent to those skilled in the art that do not depart from its scope. A skilled artisan may develop alternative means of implementing the aforementioned improvements without departing from the scope of the present disclosure.

What is claimed is:

1. A system for foaming a component of an article of footwear, the system comprising:
a solid-state microwave energy source comprising a frequency synthesizer;
a footwear component mold, the footwear component mold having a mold chamber configured to form the component from a polymer material reactive to microwave energy from the solid-state microwave energy source, the footwear component mold comprising a first material having a first value for a first microwave dielectric property; and
a press, the press capable of compressing one or more portions of the footwear component mold.

2. The system of claim 1, wherein the solid-state microwave energy source comprises an emitter capable of varying electromagnetic wavelengths, field configurations, or intensity across the emitter.

3. The system of claim 1, wherein the solid-state microwave energy source is coupled with the footwear component mold by a microwave energy conduit.

4. The system of claim 1, wherein the solid-state microwave energy source generates electromagnetic radiation in a frequency of between about 2.4 GHz and 2.5 GHZ.

5. The system of claim 1, wherein the footwear component mold comprises a second material having a second value for the first microwave dielectric property.

6. The system of claim 5, wherein the first microwave dielectric property is relative permittivity, and wherein the first value is less than the second value for a first frequency of microwave energy from the solid-state microwave energy source.

7. The system of claim 1, wherein the first value for the first microwave dielectric property is different than a second value for the first microwave dielectric property for the polymer material.

8. The system of claim 1, wherein the polymer material is thermoplastic polyester elastomer.

9. The system of claim 1 further comprising a computing system logically coupled with the solid-state microwave energy source and the press, wherein the computing system is configured to coordinate an application of microwave energy from the solid-state microwave energy source and an application of force by the press to the footwear component mold.

10. A method of manufacturing a foam component for an article of footwear, the method comprising:
introducing a polymer material into a mold chamber of a footwear component mold;
closing the footwear component mold into a closed state having a substantially fixed mold volume;
applying microwave energy across multiple frequencies to the polymer material in the footwear component mold until a start of a foaming process is experienced by the polymer material;
subsequent to applying the microwave energy, maintaining the footwear component mold in the closed state for a first time so that the foam component is formed; and
subsequent to the first time, opening the footwear component mold from the closed state.

11. The method of claim 10 further comprising forming a preform from the polymer material, wherein the introducing a polymer material into a mold chamber comprises introducing the preform into the mold chamber.

12. The method of claim 11, wherein the preform has a volume prior to applying microwave energy that is greater than a volume of the mold chamber in the closed state.

13. The method of claim 11, wherein the preform has a volume prior to applying microwave energy that is less than a volume of the mold chamber in the closed state.

14. The method of claim 11, wherein forming the preform comprises:
introducing the polymer material into a preform mold;
applying thermal energy to the polymer material in the preform mold to form the preform; and
removing the preform from the preform mold.

15. The method of claim 10, wherein the footwear component mold comprises a plurality of zones, and the microwave energy applied to one zone has at least one different characteristic than the microwave energy applied to at least one other zone.

16. The method of claim 10, wherein the polymer material is introduced as a plurality of discrete elements.

17. The method of claim 16, wherein the plurality of discrete elements are in a pellet configuration.

18. A method of manufacturing a foam component for an article of footwear, the method comprising:
introducing a polymer material comprising thermoplastic polyester elastomer into a molding chamber of a preform mold;
heating the polymer material to a first temperature;
subsequent to heating the polymer material to a first temperature, maintaining the polymer material in the preform mold until the polymer material is below the first temperature;
removing the polymer material from the preform mold, wherein the polymer material forms a preform having a first volume;
inserting the preform into a molding chamber of a footwear component mold;
closing the footwear component mold into a closed state having a second volume;
heating the preform to a second temperature by applying microwave energy from a solid-state microwave energy source comprising a frequency synthesizer that varies a frequency of electromagnetic radiation emitted, wherein the second temperature is higher than the first temperature;
subsequent to applying the microwave energy, maintaining the footwear component mold in the closed state for a first time until the polymer material of the preform cools to a third temperature; and
subsequent to the first time, opening the footwear component mold from the closed state.

19. The method of claim 18 further comprising subsequent to heating the preform and prior to opening the footwear component mold from the closed state, decoupling the footwear component mold from the solid-state microwave energy source and transferring the footwear component mold relative to the solid-state microwave energy source.

20. The method of claim 19 further comprising subsequent to decoupling the footwear component mold from the solid-state microwave energy source and transferring the footwear component mold relative to the solid-state microwave energy source:
inserting a second preform into a molding chamber of a second footwear component mold;
closing the second footwear component mold into a closed state;
positioning the solid-state microwave energy source relative to the second footwear component mold; and
applying microwave energy from the solid-state microwave energy source to the second preform within the second footwear component mold.
